(19) United States
(12) Patent Application Publication
(10) Pub. No.: US 2016/0053739 A1
(43) Pub. Date: Feb. 25, 2016

(54) SYSTEM AND METHOD FOR ARTIFICIAL GRAVITY FUELED FLUID DYNAMIC ENERGY GENERATOR OR MOTOR

(71) Applicant: Robert S. PRILL, (US)

(72) Inventor: Robert S. PRILL, Allentown, NJ (US)

(21) Appl. No.: 14/412,682

(22) PCT Filed: Mar. 17, 2014
(86) PCT No.: PCT/US14/30543

§ 371 Date: Jan. 4, 2015

Related U.S. Application Data
(60) Provisional application No. 61/799,828, filed on Mar. 15, 2013.

(51) Int. Cl. F03B 17/06

(52) U.S. Cl. CPC F03B 17/061

(57) ABSTRACT

An Artificial Gravity Fueled Fluid Dynamic Day Energy Generator/Motor that initially uses external power to spin a partially submerged low drag fluid distributor rotor that uses centrifugal force to cause fluid to flow from the center of rotation, through a plurality of Euler contoured penstocks, in a true radial direction through a high “g” artificial gravity field, which dramatically increases the fluid's kinetic energy and releases available power, before it is guided out tangentially from the distributor via a plurality of nozzles symmetrically located at a small height just above the reservoir surface (near zero lift). As the frequency of the rotor is increased linearly the fuel Artificial Gravity increases exponentially, as does the fluid dynamic available power Pa. Turbine runners on the rotor assembly capture the available power, and a positive feedback mechanical transmission couples the captured rotational power to the I/O shaft in its initialized direction.

### TECHNICAL FIELD OF THE INVENTION

The present invention relates generally to energy generation, hydro-mechanical power generation, and distributed green reusable energy.

### BACKGROUND OF INVENTION

The global economy relies on a continuous, supply of coal, oil, and natural gas, and the refinement processes, necessary to produce power for virtually every power assisted device in the modern world. With the expanding growth in industrialization in new regions of the world, (China, OPEC nations, etc.) these high energy combustible fossil fuels are increasingly in demand at alarming rates causing supply and demand record high prices in highly volatile markets.

The current trend in many nations is to reduce their dependency on fossil fuels with alternative energy technologies i.e., corn-base ethanol, hydrogen based fuels, etc. and to revive the old reusable, pollution free water, wind, and solar natural energy base technologies. All of these technologies have significant drawbacks The alternative energy technologies are synthesized fuels that don't occur in nature and as such they require significant amounts of input energy to refine and similar amounts of energy (unaccounted for by the technology) to distribute them to the end user. The reusable technologies have a different set of drawbacks. Solar, whether it is used as a centralized or distributed energy source is terribly inefficient, and it is only available during daylight hours. Wind technologies are available day and night but only sporadically and it is mainly a centralized technology, requiring vast chunks of valuable real-estate for their wind turbines and having high energy transport charges to get the energy to the user. Water based power generation is the most efficient but is a centralized technology with limited set geographic locations and suffers from the high energy transport charges to get power to the end user.

In light of the above, it is believed that the primary source of the world's energy needs will continue to come from the combustible fossil fuels of coal, oil and natural gas, (and from nuclear energy) well into the foreseeable future. It is also believed that the remedial, hot button alternative energy technologies of the day (ethanol, hydrogen based fuels, fuel cells, etc.), and the attempts of reviving the reusable technologies of wind and solar, as we know them now in their natural state with their inherent problems of unavailability (no wind or no sun) will not greatly reduce our energy dependency on fossil fuels.

### BRIEF SUMMARY OF INVENTION

The present invention includes an artificial gravity fueled fluid dynamic energy generator/motor comprising: a system control and brake assembly; a main bearing vertical shaft assembly connected to the system control and brake assembly; a platform connected to the main bearing vertical shaft assembly; a ratchet assembly connected to the main bearing vertical shaft assembly; a rotor connected to the main bearing vertical shaft assembly and wherein the rotor supports a fluid distributor; a turbine shaft connected to the rotor by at least one bearing shaft support; a turbine runner connected to the turbine shaft by a gear box; a drive gear connected to the turbine shaft; a sun gear dynamically interfaced with the drive gear, and a hub extension connected to the sun gear; wherein the fluid distributor includes at least one penstock including an associated nozzle configured to propel a fluid from a reservoir to the turbine runner.

Another embodiment of the invention includes a method of generating artificial gravity fueled fluid power, the method comprising the steps of: rotating a vertical shaft of main bearing vertical shaft assembly, an attached rotor, a fluid distributor attached to the rotor, and at least one penstock and its associated nozzle using an external cranking power in a first direction; forcing a fluid through the at least one penstock into a high artificial gravity domain where its kinetic energy is increased before it exits its associated nozzle such that the fluid impacts a turbine; rotating the turbine such that the rotation causes a rotation in a turbine shaft; rotating at least one drive gear from the rotation of the turbine shaft; causing the sun gear to spin in a first direction; slowing the sun gear down; attempting to spin the sun gear in a direction opposite to the first direction; detecting the fluid dynamic power is greater than the external cranking power; preventing the sun gear from rotating; causing the drive gear to rotate in the first direction around the now stationary sun gear; causing drive gear to drag the rotor via its turbine shaft connection to bearing shaft support connection to the rotor.

### BRIEF DESCRIPTION OF THE DRAWINGS

The drawings are meant to illustrate the principles of the invention and do not limit the scope of the invention. The above-mentioned features and objects of the present disclosure will become more apparent with reference to the following description taken in conjunction with the accompanying drawings wherein like reference numerals denote like elements in which:

FIG. 1 illustrates how Hydro-Power Generation is done today including the Earth's reservoir replenishment process;

FIG. 2 illustrates a plan to transform Earth's power generation eco system processes to artificial gravity fueled processes;

FIG. 3 illustrates a process to transform artificial gravity fueled fluid dynamic eco system to physics supported realization;

FIG. 4 illustrates a summary of transformation processes;

FIG. 5 illustrates the initial realization (vertical turbine) of artificial gravity fueled fluid dynamic energy generator/motor controlled by a closed loop braking system;

FIG. 6 illustrates the top view of a 3 channel vertical turbine rotor assembly, including positive feedback transmission;

FIG. 7 illustrates an embodiment of artificial gravity fueled fluid dynamic motor (horizontal turbine) driving electric generator;

FIG. 8 illustrates the top view of a 3-6 channel(s) horizontal turbine rotor assembly, including positive feedback transmission; and

FIG. 9 depicts the end result of the transformation process, and a typical electric grid connected application.

### DETAILED DESCRIPTION OF INVENTION

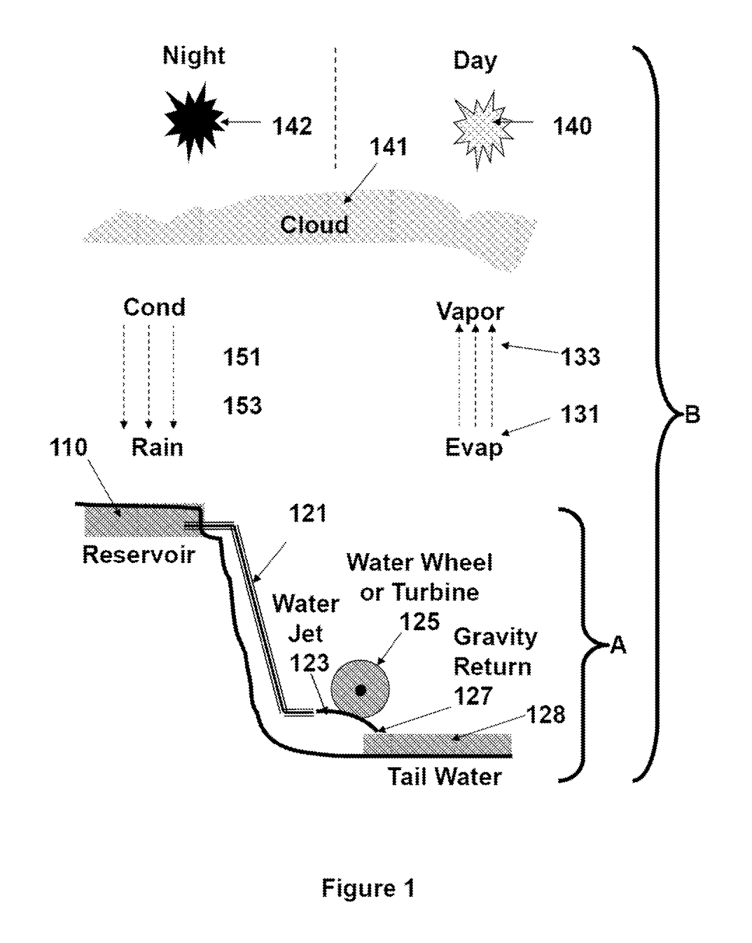

Water has a density of 700 times that of our atmosphere (wind) and seems to be the technology to zero in on for an efficient renewable energy source. The goal is to try to recreate the earth's Water Cycle Eco Support system (see FIG. 1) in a portable containment system, and put a “water fall” (hydroelectric power plant) in every house, business, auto, train, and boat. This technology, when put into mass production throughout the world, will have global disruptive, but positive impact, on changing existing trillion dollar roadmaps toward moving the world's population to a distributed energy system that will significantly reduce our dependency on fossil fuels in record time.

This invention will dramatically change the world's energy roadmap, initially suppressing the need for further development of water, wind, and solar alternative present day green renewable energy solutions, and over a much longer period of time will allow continental electrical distribution grids as we know them today to be dismantled and/or reduced to much smaller local city, town, urban area grids to handle high peak loads of undersized locally distributed equipment. The technology is in its infancy and is considered to be at the TRANSISTOR stage of development and will spawn a new age of power generation technology and untold numbers of related industrial support jobs. It is expected that within a few years' time this technology will begin to be proliferated by homeowners through the world via a simple installation kit that hooks embodiments of the present invention to the home's electric Distribution Box and onward to the grid. It is estimated that the size of the equipment will be no larger than the home's furnace.

The overall objective of the present invention is to emulate the Earth's water-cycle Eco System reservoir replenishment process, and Hydro Power generation process, and to package the system in a semi-portable containment structure; i.e., that is to: (i) transform the 24/7/365 day a year evaporation-condensation process of lifting a fluid from a lower level to a higher level; and (ii) transform the earthly process of harnessing the energy-power of falling fluid with a turbine, to a new set of processes that miniaturizes or shrink-wraps the earthly processes, but produce the same energy-power as that of the typical waterfall, as given by Eq1-1 and shown in FIG. 1:

Pa=rho*Q*g*h Eq1-1

And to produce this amount of available power Pa, to drive a turbine, in a recursive process 34/7/365 days a year, and put the energy-power generation of a waterfall in every commercial and military home, business, auto, train, boat, ship, and air vehicle.

It is a further objective of the present invention to start by hypothesizing the concept of a gravity multiplier n, where, as n is made very large, the quantity (n*g), i.e., artificial gravity, in the above equation gets very large, and for the same available power Pa, the height h can be divided by the gravity multiplier n, such that the quantity (h/n) gets very small. After this objective is accomplished, it would be a good start for “shrink wrapping” the Earth's Eco-System, and also a good start for minimizing the lifting or pumping process of getting fluid back to the reservoir, i.e., to a height of only (h/n).

It is a further objective of the present invention to transition the hypothetical gravity multiplying process to a process in the rotary domain where it is possible.

It is a further objective of the present invention to define the gravity multiplier n, as it is defined in centrifuge technology, such that the product of (n*g) is defined as artificial gravity, (i.e., the “fuel” for this system).

It is a further objective to ask and compare:
How much external energy-power does it takes to generate an artificial gravity domain of say 100 or 200 g's on a disc of radius r at its circumference?
How much fluid dynamic energy-power is generated if a partially submerged tube or penstock is coupled to the above artificial domain disc where the fluid enters the tube at the center of the rotation, flows up through a slight incline to a nozzle located just above the reservoir surface at the disc's circumferential end?

If the amount of fluid dynamic power generated at the nozzle is much greater than the amount of external power used to manufacture the 100 or 200 g's of artificial gravity, then, we have described a new Clean Energy Fuel, “artificial gravity”, a fuel that is used but never consumed, making it the cleanest of all known fuels.

It is a further objective to define the methods and processes for capturing and getting the fluid dynamic power out of the artificial gravity rotational domain and into a stationary user friendly domain.

It is a further objective to define a scalable family of Artificial Gravity Fueled Fluid Dynamic Energy Generator/Motor Embodiments that are scalable in Power output, ranging from less than a Kilo-Watt to tens and hundreds of Kilo-Watts, and beyond.

FIG. 1 depicts the Earth's hydro dynamic eco-system. When we talk about hydro power generation, as implementers and users of hydro power we generally only view the system as pictured in FIG. 1A.

FIG. 1A views Hydro Power Generation from a site view point. Is there a source of water or reservoir 110 at a higher elevation available to me, or can a dam be built to make it look that way? Whether it is a major Hydro Power Generation Plant or a private Micro-Hydro Power generation facility, sighting is the only thing that is and needs to be considered, will the reservoir or stream be at an elevation above where it can be tapped into, and will nature provide a sufficient quantity of water, and after it is used, can the waste water or Tail Water 128 find its way to the oceans? If the above conditions exist a Hydro Power Generating facility can be built. The amount of power that the facility will produce is based on the flow rate of water in the mostly vertical pipe or penstock 121 and its vertical distance to its nozzle where the water jet 123 emanates with a power available: Pa=rho*Q*g*h and strikes the waterwheel or turbine 125, where it transfers its weight, in the case of a waterwheel or its high velocity momentum, as given by a more appropriate expression containing a velocity term, Pa=½ rho*Q*v̂2 where v̂2=2*g*h for the case of a turbine which captures the power available Pa, with an efficiency, such that the power captured Pc=Efficiency*Pa and then continuously disburses the energy depleted water via gravity 127 to a tail water 128 stream that eventually finds its way to rivers and the ocean.

FIG. 1B illustrates the bigger picture. There is an eco-system support process that replenishes the reservoir 110 that takes place. An external seemingly obscure source of energy, the sun 140, warms the surface of the earth and causes surface moisture/water to evaporate 131 into a vapor 133 state and form clouds 141 at high elevations. The warming of day 140 and the cooling of the night 142, among other contributors, create winds that move the clouds over land and cause condensation 151 resulting in precipitation (rain, sleet hail, snow) 153 to fall from high altitudes, well above the earth's surface, that eventually get into the liquid state and fill the reservoirs 110 and streams.

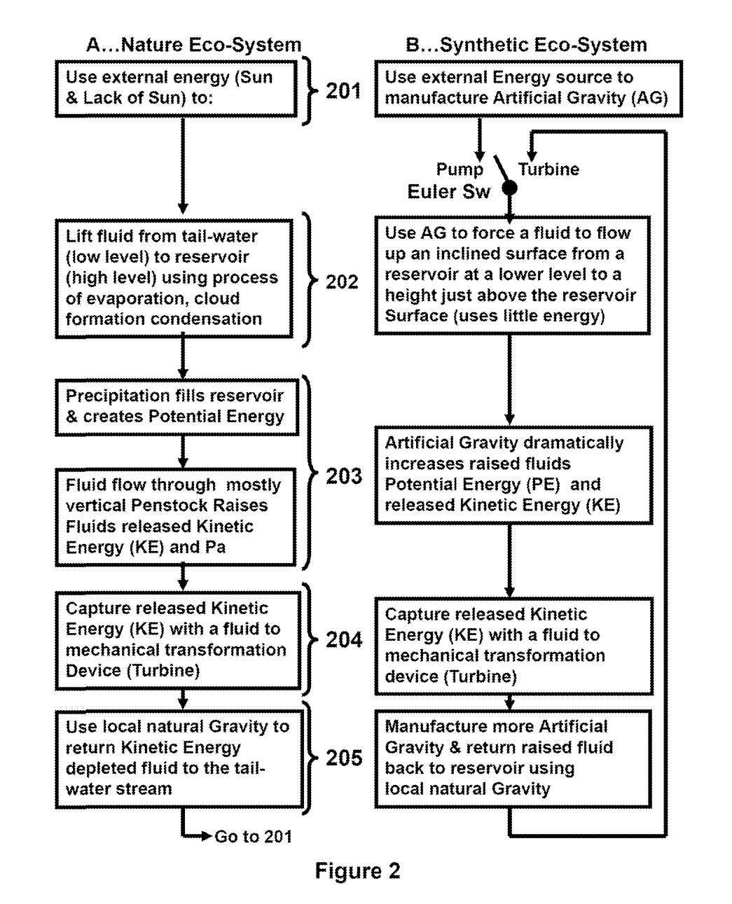

The question posed that stimulated this invention was, “Can I synthetically emulate, in highly compressed time, the earth's water cycle eco-system, house it in a portable containment structure, and put a “waterfall” and hydrodynamic energy generator in every house, auto, train boat, etc.” FIG. 2 compares the earth's behind the scene water cycle eco system processes

(Nature Eco-System) that occurs in nature (FIG. 2A), and the current invention's process (Synthetic Eco-System—FIG. 2B) that uses an external energy source to manufacture artificial gravity, and uses it to initiate fluid flow, increase the fluid's Potential Energy (PE), increase its released Kinetic Energy (KE), capture and transform the released Kinetic Energy into mechanical energy, and use that energy, before returning the depleted fluid to the reservoir via natural gravity, to manufacture more artificial gravity, such that in a recursive manner the closed loop process, mimics the processes of nature's eco water cycle system.

The following discussion (FIG. 2) compares Nature's Water Cycle Eco-System processes 2A to the invention's method of Transforming the Earth's Power Generation Eco System Process to an Artificial Gravity Fueled Process 2B and highlights the pertinent likenesses and differences.

Referring to 201, the Earth's Eco System uses an external energy source, the sun, to carry out the subsequent processes in FIG. 2A, where as in FIG. 2B, the Synthetic Eco-System, uses an external energy source to manufacture Artificial Gravity, the fluid dynamic fuel that is used in subsequent processes in the remainder of FIG. 2B. The premise here is that over time (recursively) as the external energy is increased in a linear manner the Synthetic Eco-System will manufacture Artificial Gravity that increases exponentially (actually a square law relationship) over time and will surpass and replace the need for an external energy source.

Referring to 202, the Earth's Eco-System, FIG. 2A, uses the sun 201 as a fuel to evaporate water and lift it high into the atmosphere in the form of a vapor to form clouds. The Synthetic Eco-System FIG. 2B, uses Artificial Gravity that was manufactured in 202 to force fluid from a reusable reservoir of fluid, up an inclined surface to a height just above the reservoir surface (not into the atmosphere). The process of raising a fluid to a height just above the reservoir's surface from which it was taken, requires very little energy.

Referring to 203, the Earth's Eco-System FIG. 2A, uses precipitation to fill reservoirs at high elevations, creating Potential Energy (PE). This energy source is tapped into via a mostly vertical tube or penstock to release Kinetic Energy (KE) at the turbine. The Synthetic Eco-System, FIG. 2B, uses Artificial Gravity to dramatically increase the fluid's Potential Energy (PE) and release Kinetic Energy (KE). The key fact here is that in the gravitational energy equations Pa=½*rho*Q*v̂2, where v̂2=2*g*h, the power available Pa, is equal to the product of terms, g the gravity, and h the height of the waterfall are indistinguishable from an end result. In nature g is fixed and h is the variable, in the artificial Gravity domain h is fixed and g is the variable. If we multiply g by a number, then for the same Pa end result h can be divided by that same number such that the kinetic energy KE 203 in the natural eco-system is identical to that of the synthetic eco-system, but the synthetic eco-system is much smaller.

Referring to 204, the Earth's Eco-System, FIG. 2A, captures Kinetic Energy (KE) with a fluid to mechanical transformation entity such as a turbine. In the Synthetic Eco-System, FIG. 2B, both the reaction force and the impulse force of the kinetic energy KE are captured in an additive manner, the reaction force by pointing the released KE stream to aid in producing more artificial gravity, and the momentum or impulse force with a fluid to mechanical transformation entity such as a turbine.

Referring to 205, the Earth's Eco-System uses natural gravity to return the Kinetic Energy depleted fluid to the tail water stream. The Synthetic Eco-System, FIG. 2B, uses the captured reaction and impulse forces in 204 to manufacture more artificial gravity, before it returns the fluid to the reusable reservoir under natural gravity conditions and the cycle repeats endlessly.

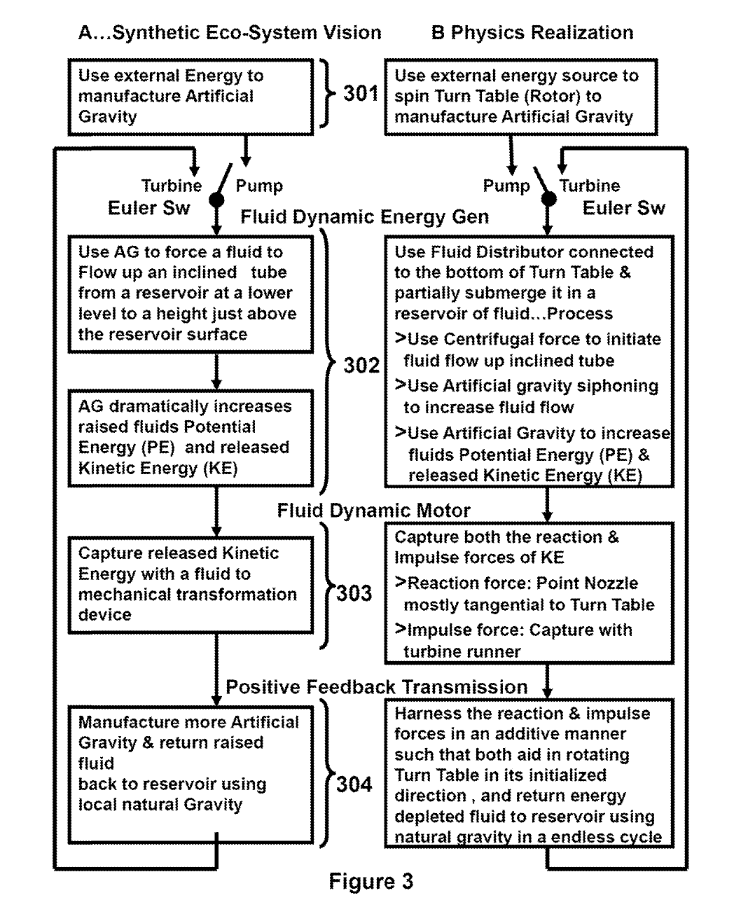

The ensemble of processes described above with reference to FIG. 2B, are the roots of the present invention. These processes will be further developed and expanded upon in the description of FIG. 3.

FIG. 3—Uses the Synthetic Eco System developed in FIG. 2B as a reference starting point to develop a more rigorous physics and fluid dynamics based foundation to each process discusses so far. FIG. 3 also moves from the Eco System phraseology and onto more appropriate Artificial Gravity Fueled Fluid Dynamic Energy Generator/Motor phraseology. To that end FIG. 3 adds Fluid Dynamic Energy Generator, Fluid Dynamic Motor, and Positive Feedback Transmission, headings to different groups of identified processes to correlate the Eco System processes to Motor/Generator phraseology.

Referring to 301, the processes of FIG. 3A illustrate that an external energy source is used to manufacture Artificial Gravity. If we relate this to how this would be implemented in the world of physics, FIG. 3B, one could initiate the spinning of a disc or turntable faster and faster to manufacture increasing amounts of artificial gravity. As soon as spinning begins two interrelated expressions of the same fuel begin, centrifugal force and a gravity normalized expression of Centrifugal Force CF, termed Artificial Gravity AG. These fuels, at any given radius (r), increase exponentially with linear increases of the turntable revolutions per minute (rpm) as can be observed in equations 3-1 & 3-2 respectively.

Centrifugal Force (CF)=(ŵ2*r) Eq 3-1

Artificial Gravity (AG)=(ŵ2*r)/g w=2*PI*f Eq 3-2

### Fluid Dynamic Energy Generator

Referring to 302, the processes of FIG. 3A, associated with using Centrifugal Force to force fluid to flow up an inclined surface from a reservoir at a lower level to a height just above the reservoir surface, and to use artificial gravity to increase the raised fluid's Potential Energy (PE), and released Kinetic Energy (KE) is formalized further in FIG. 3B. Referring to 302, FIG. 3B illustrates undisputable physics and fluid mechanics based solution to accomplish the cited objectives, and that is to preferably hard couple a fluid distributor to the turntable and to partially submerge it into a reservoir of fluid such that the input port is totally submerged at or near the center of rotation, and the output port is located just above the reservoir surface just beyond the turntable's circumference. Once rotation of the turntable with its partially submerged Fluid Distributor begins to rotate, 100% of the Centrifugal Force CF, and Artificial Gravity AG, that was manufactured under 301 above is coupled to the fluid causing:
First, CF forces fluid to flow from the center of rotation toward the circumference of the distributor and thus “primes” or fills the distributor.
Once fluid begins to flow out the orifice, Artificial Gravity begins to aid fluid flow by a process called Artificial Gravity Siphoning and for large values of Artificial Gravity (AG), Artificial Gravity (AG) dominates the fluid flow process.
The main function performed by AG is to dramatically increase the fluid's Potential Energy (PE) and released Kinetic Energy (KE).

The above processes now have Physics and Fluid Mechanics roots, and if we observe the overall functionality of these processes, in Motor/Generator terms, the functionality of the sum of these processes define the Fluid Dynamic Energy Generator portion of the present invention.

### Fluid Dynamic Motor

Referring to 303, the process in FIG. 3A is to capture and transform the Kinetic Energy stream into mechanical rotational energy, as is done in conventional Hydro Power Generation systems. In FIG. 3B the process of FIG. 3A is defined in terms of realizable physics and fluid dynamics principals. As summarized in the figure and immediately below, both components of the released Kinetic Energy (KE), the Reaction Force, and the Impulse Force of the fluid stream are captured.
Reaction Force is captured by pointing Nozzle mostly tangential to turntable.
Impulse Force is captured with a water wheel or more precisely a turbine runner whose buckets pass through the fluid stream defined above.

The above summarizes how the particular processes described in reference number 303, originally associated with the Synthetic Eco System, relate to the physics and fluid dynamic processes of the Fluid Dynamic Motor.

### Positive Feedback Transmission

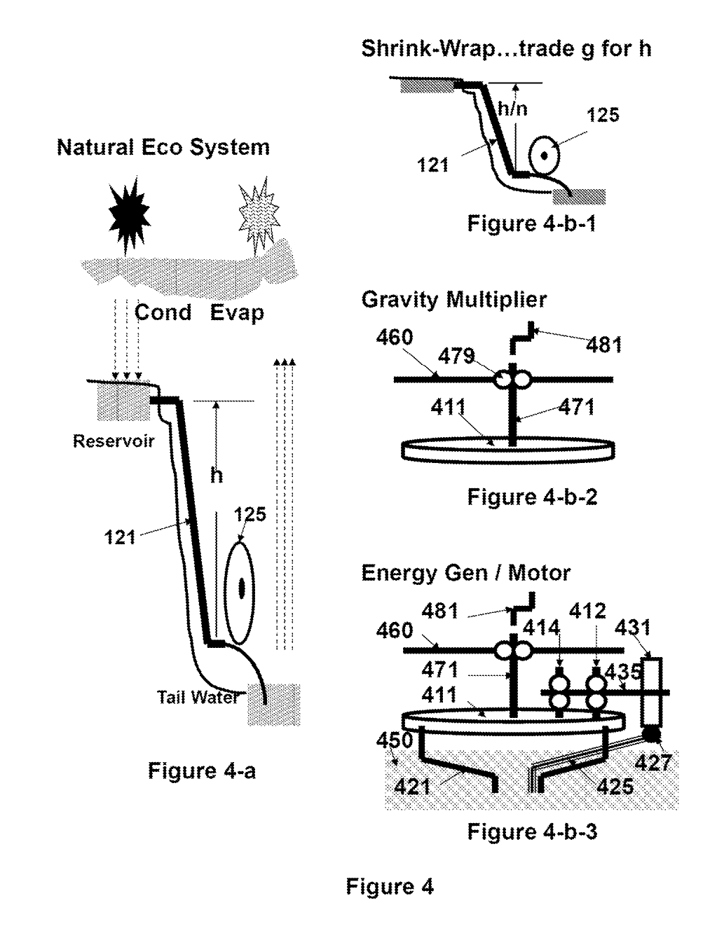

Referring to 304, the initial processes identified in FIG. 4A are to manufacture more Artificial Gravity and return the raised energy depleted fluid back to the reservoir. In the more rigorous based Physics/Fluid Dynamics solution we found a way to harness both the Reaction Force and the Impulse Force of the KE stream in an additive manner, such that both aid in spinning the turntable in its initialized direction after which the energy depleted fluid is returned back to the reservoir in an endless cycle

The above summarizes how the particular processes described in 304 relate to the Physics and Fluid Dynamic processes of the Positive Feedback Transmission processes.

FIG. 4 summarizes what was developed in FIGS. 2 & 3, highlighting the process for moving the power generating process of a typical waterfall, FIG. 4-a together with its replenishment process, to a semi-portable “shrink-wrapped” embodiment that has the same energy generating capacity as the original waterfall.

FIGS. 4-b-1, 4-b-2, and 4-b-3 provide a summary of the physics and fluid dynamic transformation processes. From this set of figures and the background information provided in FIGS. 2 & 3, a comprehensive analytical analysis follows.

FIG. 4-a depicts the typical waterfall (actually a waterfall contained in a pipe or penstock 121) originally discussed with respect to FIG. 1 and the eco-system reservoir replenishment process that supports the waterfall, allowing a turbine 125 to continuously capture the energy-power available Pa=½ rho*Q*v̂2, where v̂2=2*g*h from a typical hydro power facility, such that the power captured Pc=efficiency*Pa;

FIGS. 4-b-1, 4-b-2, 4-b-3 pictorially highlight the transformation processes developed in this disclosure to transform the earthly processes of FIG. 4-a into the small semi-portable Artificial Gravity Fuelled Fluid Dynamic Energy Generator/Motor the transformation processes being:

FIG. 4-b-1 Miniaturization or “shrink-wrapping” the earthly system;

FIG. 4-b-2 Realization of a gravity multiplier in the Rotary Domain to produce AG;

FIG. 4-b-3 Process: coupling AG to a fluid to cause fluid flow & to increase its KE;

The following analytical analysis uses well established equations mostly from the fields of Physics of Rotating Bodies, Hydro-Power Generation from falling water (gravity fuelled . . . without gravity water wouldn't fall), and centrifuge technology to develop the Clean Energy-Power Generation Technology of the present invention.

### Power Available Pa

Referring to FIG. 4-a the power available of a waterfall is given by Eq 4-1:

Pa=rho*Q*g*h Eq 4-1

### Gravity Multiplier n

In FIG. 4-a, to a first order approximation, if we introduce the concept of a gravity multiplier n in Eq 4-1, then if we multiply g by n, we can divide h by n for the same available fluid power Pa. This is the primary basis for the miniaturizing or “shrink-wrapping” the power generating capabilities of the earth's water cycle eco-system, as depicted in FIG. 4-b-1:

Pa=rho*Q*ng*h/n Eq 4-2

Besides shrink-wrapping there is a pumping process required to get the fluid back to the reservoir, in the limit as the gravity multiplier n is made large, the quantity (ng) gets large, and (h/n) approaches zero showing that Pa in Eq 4, still has the same available power Pa as the typical waterfall in 4-a above and as given in Eq 4-1. And thus will have surplus energy-power to “pump” the used fluid to a small height of (h/n) back to the reservoir. The energy needed to generate the multiplier n is included below.

A more appropriate representation of Pa for a fluid flowing from a reservoir through a penstock and nozzle is to represent the power available in terms of velocity, volumetric flow rate Q and mass flow rate (rho*Q) as shown in Eq 4-3:

Pa=1/2rho*Q*V̂2 Eq 4-3

where v̂2=2*g*h; v=Sqrt v̂2; Q=v*Anoz; rho=Fluid density; or by substitution as shown in Eq 4-4

Pa=½rho*(v*Anoz)*(2*g*h) Eq 4-4

### Implementing a Gravity Multiplier n

Even though the implementation of a gravity multiplier is impractical with a typical waterfall, it can be implemented in a rotary domain, as depicted in FIG. 4-b-2, where the subject multiplier “n”, as defined in centrifuge technology is defined by Eq 4-5:

n=(ŵ2*r)/g Eq 4-5

where w=(2*PI*f); r=radius of rotor (h/n); f=natural Freq of rotor; and g=local gravity; or via substitution

n=((4*PÎ2*r)/g)*f̂2 Eq 4-6

where ((4*PÎ2*r)/g)=constant.

Indicating that n, the gravity multiplier grows exponentially with only linear changes in frequency of rotation. To simplify the analysis, the multiplying force acts orthogonal to local gravity (external energy source turns “Crank 481” which spins Vertical Shaft 471 that protrudes through stationary platform 460 via bearing support 479 and via its hard connection to rotor 411 spins horizontally oriented Rotor 411). Since the two gravity domains are orthogonal in this configuration local gravity and artificial gravity (n*g) can be treated independently.

### Penstock-Nozzle Orientation in Artificial Gravity Domain

Since the two gravity domains are independent, and (h/n) is a small contributor to Pa, when transitioning to the rotary domain, the Reservoir and Nozzle/Turbine can be interchanged as depicted in FIG. 4-b-3 and positioned in a mostly horizontal orientation. The term mostly, in this instance, is for practical reasons, requiring the reservoir to be either slightly above the nozzle (requires the aforementioned (h/n) pumping process), or the reservoir to be slightly below the nozzle as shown in FIG. 4-b-3, such that the fluid in the Penstock 425 can be used by the turbine runner 431, and the energy depleted fluid returned to the reservoir by local gravity.

Ideally, it is desirable to position the penstock 425 in FIG. 4-b-3 mostly in the radial direction, where the intake port of the penstock 425 is positioned one to two penstock radius deep at center of rotation of the artificial gravity domain, and one to two penstock radius above the reservoir 450 surface at its circumferential nozzle end of the artificial gravity domain, leaving the middle portion of the penstock 425 submerged for “Priming” purposes), as shown in FIG. 4-b-3 allowing:
CF to prime the system and get fluid to flow out the nozzle 427;
Local gravity to return the energy depleted fluid (after it impacts the turbine runner 431) directly back to the Reservoir 450 without a pump.

Also for practical reasons, two or more Penstocks are required for dynamic balance reasons, requiring the radial portion of the Penstocks to be slightly off set from the axis of rotation, at a small radius r1.

### Euler Turbo Machine Theory

According to Euler Turbo Machine Theory, when we rotate a fluid around an axis, as in an impeller, or in our case radial penstock(s) 425, the external energy required to overcome the momentum of fluid that is trying to follow a straight line radial path within the penstock to the circumference, as we rotate or continually change the radial orientation (azimuth) of the penstock(s) around their axis of rotation, takes a significant amount of energy. We are continually bending the fluid momentum force via the fluid's contact with the ever changing position of the penstock 425 walls. This Euler Turbo Machine energy that is acting contrary to the cranking energy supplied to crank 481 can be reduced to near zero by changing the notional radial penstock to a radial curved Penstock.

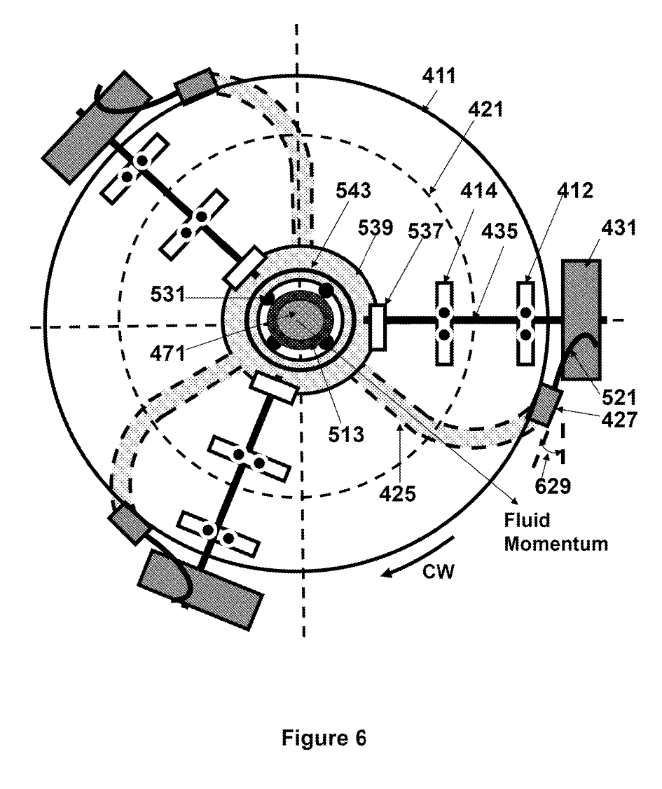

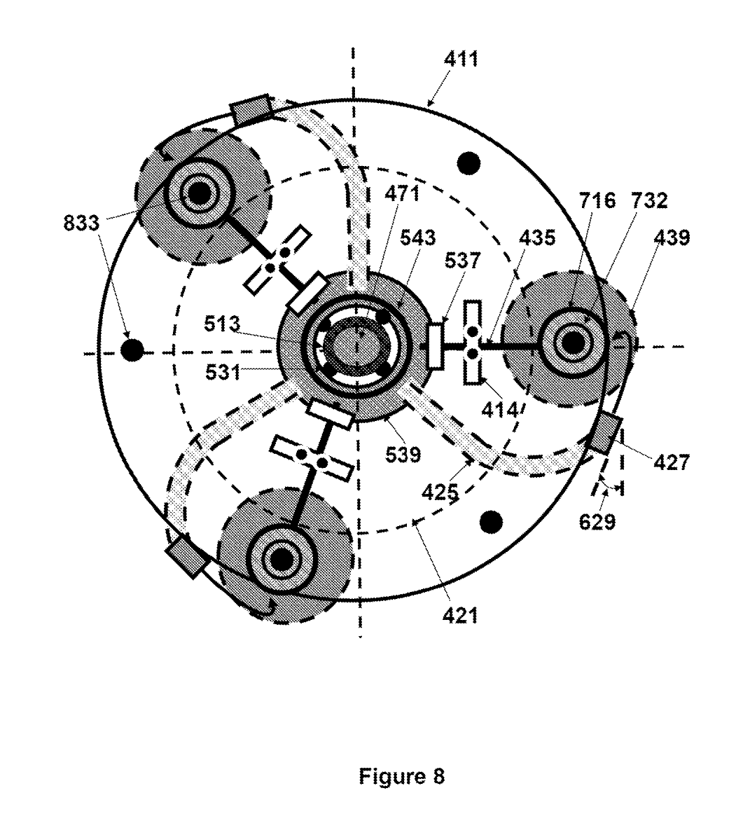

By curving the penstock(s) 425, from its normal radial direction, (beginning at its point of entry r1 into the horizontal rotating domain), outward to a point on the circumference of the Rotor 411 that is moving toward the normal radial (had the penstock(s) not been curved), at a rate such that a fluid particle in the curved penstock flows unperturbed (along a streamline) in its natural radial direction without ever encountering a wall of the continually rotating penstock 425 until it exits via nozzle 427, thereby keeping the external rotational forces to those described earlier: Main Bearing friction, plus Atmosphere drag, plus Fluid Dynamic drag that are all very small. The descriptions of FIGS. 6 and 8 further elaborate this fundamental concept.

So the power available in the rotary domain of FIG. 4-b-3 emanating from the radial curved penstock 425, via its nozzle 427 is correct as given by Eq 4-7

### Calculating Artificial Gravity Fuelled Power Available

Pa=½rho*(v*Anoz)*(2*(n*g)*r) Eq 4-7

where r=(h/n).

And where, looking ahead, there are either 3, or 6 Nozzles in a typical system, say for a Home-Business, where each Nozzle puts out 1 to 3-5 gallons per second So Eq 4-7 tells us, recognizing (2*ng*r) is V̂2, Eq 4-7 can be written as:

Pa=½rho*v̂3*Anoz Eq 4-8

Eq 4-8 is another expression for available power Pa, which is helpful to use to estimate Pa, as a function of velocity, nozzle orifice area, defined as Anoz, and fluid density alone, without regard to any other parameters, including the amount of Artificial Gravity (n*g) or nozzle swept diameter, or rotor RPM.

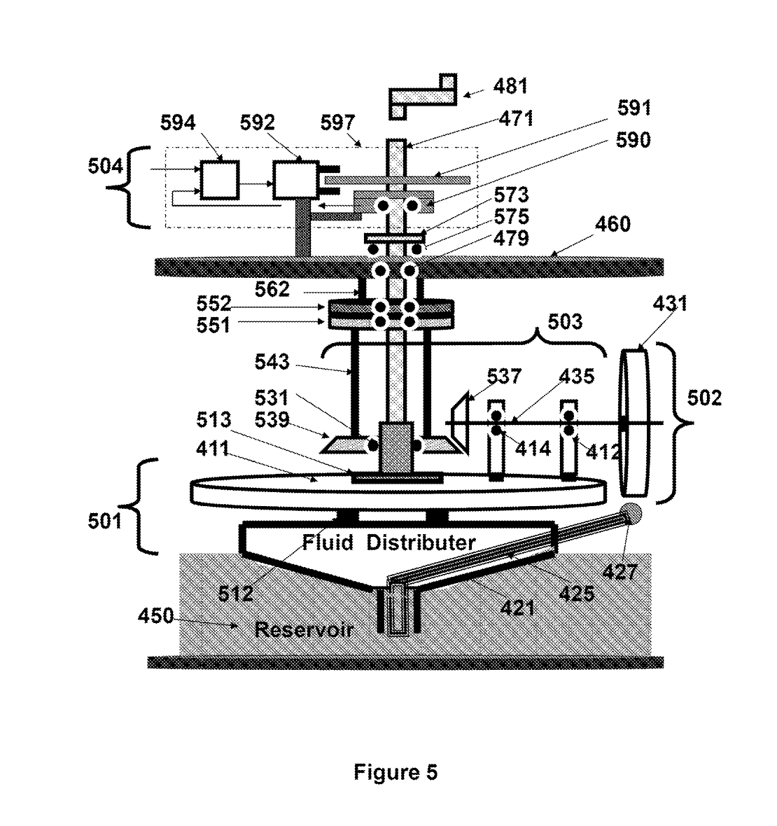

FIG. 5, titled Initial Realization (Vertical Turbine) of Artificial Gravity Fueled Fluid Dynamic Motor depicts a so called “Text Book” embodiment view of the invention. Text book view refers to the most rudimentary view of the invention that includes all relevant entities required to describe the invention's Principals of Operation, in terms of classical physics and fluid mechanics engineering principals, but without superfluous items that detract from the description. Don't let the term Text Book view imply that the vertical Turbine 431 is not recommended for production, on the contrary, the Vertical Turbine 431 implementation is probably the most efficient and least costly implementation (after partitioning collections of small parts into testable subassemblies for production and maintenance) of this technology. The System Control and Brake Assembly 597 includes controller 594, disc brake 592, brake disc 591, and shaft encoder 590.

Referring to FIG. 5, in operation, assume the entire system is at rest. We engage the Crank 481 (Crank is for illustration purposes only and represents an external energy source) to the Vertical Shaft 471 and begin supplying increasing amounts of external rotational energy to the Vertical Shaft 471 rotating it faster and faster in the Clockwise (CW) direction (alternatively in the counter clockwise (CCW) direction, but then all future references to theses directions need to be reversed), where said shaft is supported in the vertical direction by Shaft Collar 573 and Thrust Bearing 575 to the platform 460 of the Fluid Dynamic Energy Generator/Motor. The main vertical Shaft 471 is further supported by Axial Bearing 479 for rigidity in the horizontal or axial directions before it passes through Ratchet Assembly 552 and 551, (the Euler Switch in FIGS. 2 and 3) and into the Hub 513 to which it is preferably hard coupled. The Hub 513 in turn is preferably hard coupled to the Turn Table or in Motor Generator technology to the Rotor 411 and thus Rotor 411 begins to rotate faster and faster in unison with the cranking force, at the same frequency of rotation and in the same Clockwise (CW) direction.

### Fluid Dynamic Energy Generator 501

The above process of rotating the Rotor 411 in the Clockwise (CW) direction immediately begins the process of manufacturing Artificial Gravity (AG) and Centrifugal Force (CF), the two inseparable “fuels” that are used within the Fluid Dynamic portion of this invention. Both of these fuels grow exponentially (actually a square law growth) with linear increases in frequency (f) or rpm of the Rotor 411 as shown in their expanded frequency domain forms, and also showing, once an r is selected, the only variable left is f̂2

$$\begin{matrix}\begin{matrix}CF = ( w \hat{} 2 * r ) = ( 4 * PI \hat{} 2 * f \hat{} 2 * r ) \\ = ( 4 * PI \hat{} 2 * r ) * f \hat{} 2\end{matrix} & Eq 5 \text{-} 1 \\ AG = ( w \hat{} 2 * r ) / g ) = ( ( 4 * PI \hat{} 2 * r ) g ) * f \hat{} 2 & Eq 5 \text{-} 2\end{matrix}$$

Linear gradients, as a function of radius r, of CF and AG, are manufactured by the rotating Rotor 101 and these gradients increase exponentially (actually a square-law relationship) with linear frequency changes in Rotor 411 rotation.

By hard coupling, via supports 512 a Fluid Distributor 421 to the Rotor, nearly 100% of the manufactured CF and AG that is manufactured by the Rotor 411 is coupled to the Fluid Distributor and to any fluid submerged within the mostly radial penstock 425 This shows that at some frequency f, CF will begin to noticeably force, and constantly replenish, fluid in the submerged portion of penstock 425 to flow up its slightly inclined surface toward its circumferential end nozzle 427. As the frequency of rotation is increased further CF fills the penstock 425, and as the frequency is increased further yet, a steady stream of fluid emerges from the nozzle 427 and a new phenomenon of up-hill Artificial Gravity siphoning begins to aid the CF in fluid flow process. The Fluid Distributor's external shallow funnel shape is designed to present a low drag force that otherwise would not be present if the penstock 425 had to be dragged through the fluid.

Simultaneously, with the aforementioned fluid flow process, the fluid's velocity emanating from the nozzle 427 begins to increase, where the power available Pa, from this flow is given by Eq 4-3 developed in the description of FIG. 4:

Pa=½*rho*Q*v̂2 Eq 4-3

Where v̂2=2*(n*g)*r; v=Sqrt v̂2=vj; Q=v*Anoz; rho=1000 Kg/M̂3. So by substitution and transformation into the artificial gravity AG domain Eq 4-3 becomes:

Pa=(½)*rho*(vj*Anoz)*(2*(n*g)*r) Eq 5-3

### Fluid Dynamic Motor 502

The Fluid Dynamic Motor process captures the released Kinetic Energy (KE) from the Nozzle 427 on the circumferential end of the radially curved penstock(s) 425 and constructively captures both the Reaction Force and the Impulse Force of the KE stream emanating, from Nozzle 427. The Reaction Force of the KE stream is captured because its nozzle 427 is pointing in a direction that is mostly tangential to the Rotor 411 circumference.

The Impulse Force of the KE stream is captured with a fluid to mechanical transform entity, known in the fluid dynamics field, as a Turbine Runner 431. The particular type of Turbine Runners 431 that fit this application are the Pelton and Turgo style of Runners. These types of runners extract energy from the momentum or impulse of a moving fluid as opposed to its weight like the traditional overshot waterwheel. These types of Turbine Runners are designed to handle the flow rate and velocities of the KE jet of fluid emanating from nozzle 427 and have a bucket geometry designed such that when the rim of the turbine runner runs at 1/2 the speed of the KE water jet vj, emanating from nozzle 427, maximum power is transferred to the Vertical Turbine Runner 431.

In traditional applications the runner speed is set by the available head of fluid (water) at a particular site, and the mechanical reflected braking load on the runner is adjusted to cause the Vertical Turbine Runner 431 circumference to rotate at half the KE jet stream velocity.

In the subject Artificial Gravity Fueled Motor of FIG. 5 the dimensional scaling of the rotor 411 radius, the vertical turbine runner 431 radius, the nozzle 427 diameter, and the gear ratios of the Drive Gear (DG) 537 to Sun Gear (SG) 539 are specified to produce the 2 to 1 ratio of nozzle 427 jet velocity to vertical turbine runner 431 circumference velocity over a wide range of rotor 411 rpms allowing a single Fluid Dynamic Motor design to be used in a wide variety of applications. This is fully described below.

### Positive Feedback Transmission 503

For a desired power output per Fluid Dynamic Channel, the Positive Feedback Transmission is designed to appropriately adjust the speed ratio between the Rotor 411 and Vertical Turbine Runner 431 such that at any given Rotor rpm, the Rotor 411 manufactures enough AG to support a nozzle 427 velocity, two times that of the Turbine velocity. The Vertical Turbine Runner 431 diameter and two Positive Feedback Transmission gears control this ratio, the Drive Gear (DG) 537 and the Sun Gear (SG) 539.

As an aside, during start up the Sun Gear 539 is free to rotate CW by its connection to the free-wheeling Ratchet Assembly 551 via sun gear hub extension 543 that is preferably hard coupled to SG 553. The SG 539 is being dragged in the CW direction by DG 537 (not yet rotating . . . no fluid flowing or no fluid flow strong enough to brake static friction of the Vertical Turbine Runner 431 and the Positive Feedback Transmission, parts under parenthesis 503, up through half of the Ratchet Assembly 551) by its connection to bearing shaft supports 412 and 414 and a rotating rotor 411. At higher frequencies of rotation, the Kinetic Energy of the stream becomes strong enough to break static friction of the Vertical Turbine Runner 431 and associated Positive Feedback Transmission, DG 537 and SG 539, and thus begins to turn the yet unrestrained Sun Gear (SG) 539 with very little torque at a velocity close to the KE jet velocity, Vj, emanating from Nozzle 427 in a direction to slow the SG 539 down, from the view point of the platform 460, to the point that the SG 539 tries to go from CW rotation through zero rotation and thus reverse it's apparent direction of rotation as observed by the Ratchet Assembly 551 (Euler Switch), that is referenced to the platform 460 via its connection hub 562 to the Main Bearing extension 776, to CCW rotation, at which point this condition is detected by the Ratchet Assembly 551 & 552, and the Sun Gear (SG) 539 via sun gear hub extension 543 and is locked to a nonrotating platform 460.

At this point, the real power generation process begins. The DG 537 now exerts a force on the now nonrotating Sun Gear (SG) 539 and the DG 537 now begins to rotate around the SG 539, causing the Rotor to be forced to rotate faster than it had been rotating via vertical shaft 471's connection via hub 513 and rotor 411 to bearing shaft supports 412 and 414, and DG 537 now rotating around the now stationary SG 539. The bottom line effect of this is the Rotor 411 begins to rotate at a slightly faster rotational rate than the External Energy Source 481 is rotating it, thereby incrementally incrementing artificial gravity, which increases the released Kinetic Energy emanating from nozzle 427, which increases the velocity, Vj, of fluid emanating from nozzle 427, which increases the Vertical Turbine Runner 431 circumferential velocity and the DG 537 speed causing the rotor 411 speed to incrementally increase, in an recursive cycle, eventually attaining a rotational speed or rpm that completely replaces the External Energy Source 481 that it took to get the Rotor 411 to this energy producing state.

From the above discussion, if the Rotor 411 is left unloaded without a Braking force applied to the rotor Vertical Shaft 471 it will within a matter of seconds, be damaged. To prevent this, the Fluid Dynamic Motor needs to have a braking load commensurate with the Torque or Horsepower that it develops as a function of the Rotor's 411 rpm, applied to its output Vertical Shaft 471.

### Controlling the Fluid Dynamic Motor Speed 504

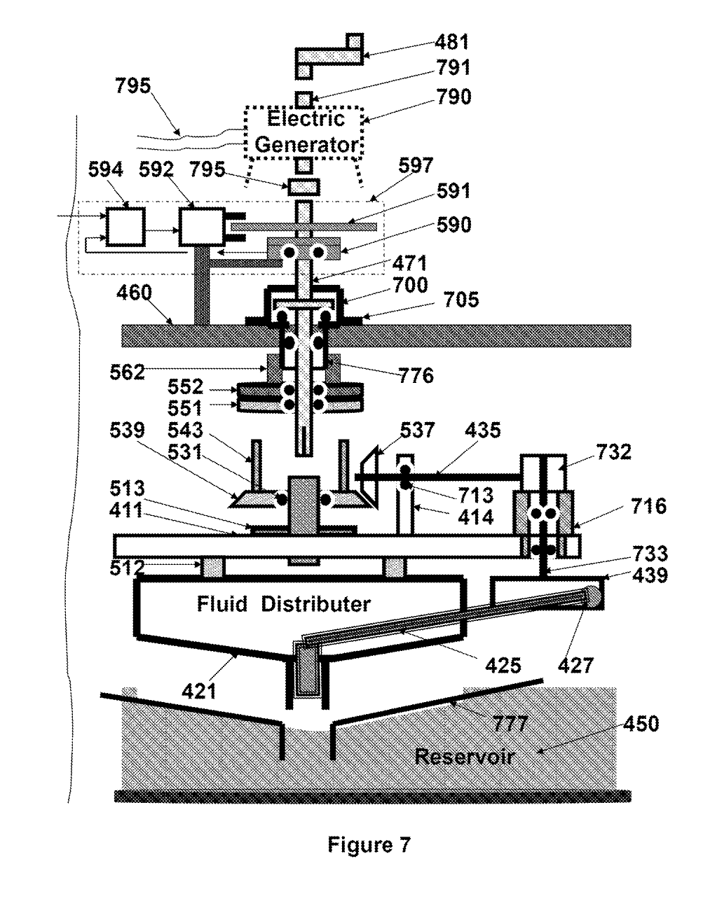

The depicted closed loop braking system, comprised of shaft encoder 590, the control function 594, the disc brake 592 and the braking disc 591 that is affixed to the Vertical Shaft 471 provides a practical solution to control the Fluid Dynamic Motor's Rotor rpm. The Closed loop control braking system can be used as a standalone braking load on the Fluid Dynamic Motor as depicted in 504, or as a control function when the Fluid Dynamic Motor is driving via vertical shaft 471 an Electric Generator 790 as depicted in FIG. 7.

In either case, before any external rotation energy source is activated, an operating rpm is loaded into the Controller 594 and the controller recognizes that the rotor is going too slow (it is stopped at this point in time) and it releases the braking function. As increasing amounts of external rotational energy are applied to the rotor via vertical shaft 471 the rotor 411 begins to rotate faster and faster, and eventually attains a rotational speed or rpm that completely replaces the external energy source 481, at which time the external energy source 481 is functionally disengaged, and the Fluid Dynamic Energy Generator/Motor via its Positive Feedback Transmission continues driving the rotor 411 faster and faster each cycle manufacturing more and more Artificial Gravity, increasing the released KE until the rotor 411 rpm, as detected by the Shaft Encoder 590, begins to approach the preset rpm. The Feedback Controller then begins applying a disc brake 592 force on the Brake Disc 591 that is preferably hard coupled to Vertical Shaft 471 slowing the Vertical Shaft 471 towards its preset rpm using at a minimum, a 2^{nd} order closed control loop. The control loop then forces some overshoot and the control loop causes the rotor 411 to hover around its preset rpm. Optionally, if the disc brake 592 were outfitted with a sensor that measured Brake Force on the Brake Disc 591, Torque and Horsepower at any operational speed can be calculated. The above described control function is baseline. Set the rpm and the Fluid Dynamic Motor will run at that RPM providing any external load on the output shaft stays within the fluid dynamic power capability for that rpm setting; the control loop braking function will preferably adjust the amount of braking to maintain the preset rpm.

As an alternate, the control loop can be programmed to track large load variations by dynamically adjusting the rpm of the Fluid Dynamic Energy Generator/Motor. For instance, if the controller 594 receives a command to go to a higher rpm, the disc brake 592 is decreased and the Fluid Dynamic Motor slews up to that rpm as sensed by the closed loop braking system and again in a continuous manner adjusts the brake to either increase its braking force when the measured rpm as determined by shaft encoder 590 exceeds the reference rpm or decrease disc brake 592 force when the rpm falls below the reference rpm, and thus forces the rotor 411 to hover around the desired rpm. Again if the disc brake 592 were outfitted with a sensor that measured brake force on the brake disc 591, torque and horsepower at any operational speed can be calculated.

If the controller 594 receives a lower rpm command, the braking force is increased until the rotor speed slews down to that rpm as sensed by the closed loop breaking system and again in a continuous manner adjusts the brake to decrease its braking force when the measured rpm approaches the commanded rpm and continues to slow the rotor 411 until it falls below the reference rpm where it decreases the braking force the rotor 411in an endless cycle causing the rotor 411 to hover around the desired rpm.

The above provides a detailed explanation of how the Positive Feedback Fluid Dynamic Motor reacts to step changes in rpm commands. For positive step changes, immediately after the step change the braking force is minimized, allowing the Rotor 411 to slew toward the new commanded Rotor 411 rpm. For negative step changes, immediately after the step change the braking force is increased further from what it was in its steady state, causing the rotor rpm to slew toward the new commanded rotor 411 rpm. This information is necessary when designing the control Loop for the normal case where an Electric Generator that makes up the majority of the braking load on vertical shaft 471 has step changes in electrical demand that are reflected back to the shaft as either more braking or less braking.

FIG. 6, depicts a Top view of 3 Channel Energy Generator, Motor and Positive Feedback Transmission, highlighting the pertinent Fluid Dynamic elements and the Positive Feedback Transmission.

### Fluid Dynamic Elements

The fluid dynamic elements are radially curved penstock(s), 425, shown dashed as they reside under the Rotor 411 and nozzle(s) 427 shown tangential to Rotor 411.

The angular placement of the turbine shaft 435 with respect to its corresponding penstock nozzle 425 is placed such that, if a radial were drawn to the tangent point on the rotor 411 where vj emanates from the nozzle 427, the turbine shaft is skewed from that radial by the specified Turbine Runner angle of attack 629.

The above placement allows the nozzle 427 to be tangential to the rotor 411 for optimal reaction force recovery, and simultaneously have the specified optimal angle of attack 629 to the Turbine Runner buckets for optimal momentum or impact energy-power recovery of vj by the Vertical Turbine Runner 431.

### Positive Feedback Transmission

The Positive Feedback Transmission is comprised of turbine shaft 435, DG 537, SG 539, plus ancillary bearing shaft supports 412 and 414 preferably hard coupled to Rotor 411, and to a SG 539 control function that either allows the SG 539 to free-wheel or spin in the CW direction or be locked to a stationary reference, as controlled by a free-wheeling Ratchet Assembly (Euler Turbo Machine Switch). The Ratchet allows CW rotation of the Sun Gear 539 (Euler's Pumping mode . . . no fluid dynamic power is yet available, or fluid dynamic power is less than the external energy-power required to spin the Rotor 411, but not CCW rotation of the Sun Gear 539 (Euler's Turbine mode . . . fluid dynamic power is greater than external power and thus spins the Rotor 411), functionally disconnecting the external “cranking energy” crank 481, turning the external electric motor function into a Generator.

### Define Reference System . . . Power Generating Analysis

Since the normally dominant Euler fluid dynamic tangential momentum forces are zeroed out (or nearly zeroed out) by the curved penstocks, the gravitational model developed thus far is perfectly acceptable for analyzing the expected performance of the system of the present invention, and in particular defining the energy-power available Pa, that can be developed in an artificial gravity environment. Eq 5-3 specifies the power available Pa:

Pa=(1/2)*rho*(vj*Anoz)*(2*(n*g)*r) Eq 5-3

Defining a Reference System with the following parameter transformed into SI notation:
r=0.5 m
f=600 rev/min*1 min/60 S=10 rev/s f̂2=100
Pi=3.14156
n=(ŵ2*r)/g*f̂2=(4*9.86939*0.5)/9.8*f̂2=2*f̂2=200
vĵ2=(2*(n*g)*r)=(2*200*9.8*0.5)=1960 m̂2/s*2
v=Sqrt 1970=44.2 m/s
Anoz=1 in̂2*0.00064516 m̂2/in̂2=0.00064516 m̂2
rho=1000 Kg/m̂3

So by substitution, the per channel power available is:

$$\begin{matrix}P a = ( 1 / 2 ) * rho * ( vj * Anoz ) * ( 2 * n * g * r ) \\ = ( 1 / 2 ) * 1000 * ( 44.2 * 0.00064516 ) * ( 2 * 200 * 9.8 * 0.5 \\ = 28 KW\end{matrix}$$

$$For 3 Turbine Runners = 84 KW$$

84 KW is an amazingly large amount of fluid dynamic power available Pa. It indicates that, if we put the above Reference System parameters into an embodiment and rotate the rotor at 600 rpm this available power Pa will be generated.

The amount of external energy-power required to spin the rotor is primarily the energy required to overcome the bearing 575 and bearing 479 friction, plus the aero-dynamic drag of the Rotor 411, plus fluid dynamic drag of the partially submerged shallow funnel shaped Fluid Distributor 421. The Euler Turbo Machinery tangential momentum force is zeroed out (or nearly zeroed out) as described in the description of FIG. 4 by radial curved Penstock(s) that allows a particle of fluid in the penstock to flow in a radial stream line that never intersects the sidewalls of the rotating penstock. Based on these facts the external input energy-power is very, very small (1 to 2 KW estimated) compared to the Fluid dynamic power being generated (84 KW) at the Reference Systems operational RPM (600 RPM) and forms the basis of the present invention.

In the above Reference System in the analytical analysis we purposefully picked the physical size of the rotor radius r=0.5 meters so that the v̂2 term (2*(n*g)*r)=(n*g), and the gravity multiplier expression reduces to n=(2*f̂2). We also picked a typical expected number for a nozzle opening that has an area Anos=1 incĥ2, leaving the RPM of the Rotor the only remaining variable for this Reference System.

From the above, a Rotor speed of only 600 RPM (10 rev/sec) produces a huge amount of Fluid Dynamic power available Pa. With the physical sized selected how the volumetric flow rates, fluid velocity, and Pa vary as a function of Rotor RPM can be observed from start-up to its final operating RPM.

FIG. 7 titled, Embodiment of Artificial Gravity Fueled Fluid Dynamic Motor (Horizontal Turbine) Driving Electric Generator is shown as an embodiment in the form of an exploded view to help highlight the concept of sub assemblies, and its producibility and maintainability. From this Figure and its discussion, one of ordinary skill in the art would appreciate that all of the sub subassemblies defined below are directly applicable to the Vertical Turbine configuration previously discussed in FIGS. 5 and 6, and applicable to other Turbine configurations not discussed in this disclosure.

### General Description

FIG. 7 shows the Main Bearing Vertical Shaft Assembly 700 including the Vertical Shaft 471, which have mechanical interfaces both above and below the platform 460.

### Above Platform 460

FIG. 7 also shows the platform 460 supporting the Main Bearing Vertical Shaft Assembly 700 by a flange. The Vertical Shaft protruding from the top of the casing employs a tapered spline over which the Electronic Shaft Encoder 590 is inserted and secured via a threaded nut, then the Brake Disc 591 is attached and secured. The Electric Generator 790 is attached, to the main Vertical Shaft 471, by Coupling 795.

### Below Platform 460

The Main Bearing Vertical Shaft Assembly 700, protrudes below platform 460 as does the Vertical Shaft 471. The bottom portion of the Main Bearing Vertical Shaft Assembly 700 is machined with a tapered spline and has a precision relationship to the center of the Vertical Shaft 471, and thus provides a solid, non-rotating home for the top half of a Ratchet Assembly 552 which free wheels around hub 562.

The bottom portion of the vertical shaft 471 mates with the hub 513 of the Rotor 411 via a tapered spline and positions the Rotor 411 over a reservoir 450 of Fluid such that the Fluid Distributor 421 that is preferably hard coupled 512 to the Rotor 411 is partially submerged in the Reservoir 450.

### Detailed Description . . . From a Producibility and Maintainability Viewpoint

The above description demonstrates that the horizontally oriented Horizontal Turbine Runner 439 referenced in FIG. 7 was configured to have the identical performance to that of the vertically oriented Vertical Turbine Runner 431 in FIG. 4. Accordingly, it was decided that the following exploded view discussion should focus on transitioning the rudimentary functional mechanical concepts used to define the initial Vertical Turbine embodiment of FIG. 4 to a more producible and maintainability design with a goal of maximizing commonality between Vertical and Horizontal configurations. To that end many of the individual piece parts depicted in the Vertical Turbine embodiment of FIG. 5 have been grouped into sub-assemblies in FIG. 7, that have minimal interfaces to other individual parts and sub-assemblies, including a common high torque tapered spline non-slip shaft to component hub for quick connect/and disconnect interface that offers precision alignment and blind mating. The following sections describe the functionality of each major sub-assembly and mechanical interconnect. What is described below equally applies to the embodiments of the Vertical Turbine in FIG. 5.

### Main Bearing Vertical Shaft Assembly

In FIG. 5, the functional requirement for a means to support the Rotor 411 assembly was recognized via the individual piece-parts with the identification of a Vertical Shaft 471, an integral shaft Collar 573, Thrust Bearing 575 and Axial Bearing 479. It was shown in the context of function requirements. In FIG. 7, a Main Bearing Vertical Shaft Assembly 700 is identified, which integrates the above said functional group of parts into one testable Assembly 700 and expands its functionality to act as a support structure for the Ratchet Assembly 551 and 552 function below it. By incorporating on the Main Bearing extension 776 that protrudes below the platform 460 a machined slightly tapered spline that can be used by the top half of the Ratchet Assembly 551 & 552 via its hub 562 an anchoring facility and snug connection to a stationary reference that is aligned with vertical shaft 471.

### Ratchet Assembly

The Ratchet Assembly 551 & 552, also known in literature as a Ratcheting Freewheel Mechanism (Van Anden 1869) or Free Wheeling Ratchet Assembly that is used in the rear hubs of bicycles to allow the rear wheel to rotate faster than power train (peddles) which is analogous to the function require here. During initialization, the ratchet 551 must freewheel. In the power generation mode when the fluid Dynamic power exceeds the external power, the Ratchet Assembly 551 & 552 engages and prevents the SG 539 from rotating.

The upper half of Ratchet Assembly 551 & 552 preferably includes an integral donut shaped hub extrusion 562 where the inner portion of the extrusion is machined to include a slightly tapered spline that snugly fits over the machined end of the Main Bearing extension 776, providing the proper alignment and anchoring of the Ratchet Assembly 551 & 552 to the Main Bearing Vertical Shaft Assembly 700, that provides a secure robust connection, aligned with the main vertical shaft 471, to a nonrotating platform 460.

The Bottom half of the Ratchet Assembly 551 preferably includes a hub-like, slightly tapered spline, internal to the bottom half of the Ratchet 551, that preferably blindly engages with the sun gear hub extension 543 that acts as a shaft, having a mating machined tapered spline, such that when the Main Rotor Assembly Hub 513 is pushed on to the Vertical Shaft 471, the Sun Gear Spacer Shaft 543 also blindly engages with the bottom half of the Ratchet Assembly 551 & 552.

### Rotor/Hub Assembly

The Rotor Hub Assembly is comprised of two separate parts, the Rotor 411, and the Hub 513. The Rotor's main function other than manufacturing Artificial Gravity is to house the Fluid Distributor 421, the Turbine Runner 431 and Bearing Assembly 414, and the Positive Feedback Transmission including the vertical to horizontal shaft translator 732, turbine shaft 435, bearing support 414, DG 537 and SG 539. Preferably, it needs to support the identified items listed above in the Artificial Gravity environment it manufacturers, and be compatible from the stand point of corrosion, and other reactions with the Reservoir Fluid being used. With that said the Rotor 411 can be configured as a circular plate or to save weight as an arm (looking ahead actually as 3, or 6 arms having equal angular spacing between arms of 120 degrees, or 60 degrees respectively). In either case whether it is a disc or arms, the center or axis of rotation portion of the rotor 411 preferably supports the Fluid Distributor 421 and at the extremity or circumferential end portion of Rotor 411 it preferably supports the Turbine Runner 431, its Bearing Support Assembly 716, the Vertical Shaft to Horizontal Shaft Gear Box 732 and the remainder of the Positive Feedback Transmission, turbine shaft 435 and DG 537 and Bearing Support 414.

The Hub 513 has two basic functions, it's first function is to provide the means of attaching the Rotor 411, including everything it houses, to the vertical shaft 471 of the Main Bearing Vertical Shaft Assembly 700, and its second function is to provide a permanent place to secure the Sun Gear 539 of the Positive Feedback Transmission of the Vertical and Horizontal Turbine embodiments when the Rotor 411 is disconnected from the vertical shaft 471. To satisfy these requirements Hub 513 is extended vertically, beyond where it would be, and its exterior machined and hardened to provide an accurately aligned home for the Sun Gear 539 of the Vertical and Horizontal Turbine embodiments, This feature allows the entire Rotor 411 to be assembled with its Fluid Distributor 421, Turbine Runner 431, and Positive Feedback Transmission at the factory for all the Vertical and Horizontal Runner Configurations and allows the entire Rotor Assembly to be dynamically balanced and tested before shipment.

To satisfy the normal functionality of a hub, that is to provide a means of attaching the Hub 513 to the vertical shaft 471, the internal circumference of the Hub 513 is preferably machined half way through the Hub with a tapered spline to match that of vertical shaft 471 and a reverse tapered spline coming up from the bottom side of the Hub for using the Rotor Assembly in applications where the main vertical comes up from within the reservoir. In either case the length of penetration of the splined portion of either vertical shaft into the Hub is sufficient for it to protrude out the opposite side of the Hub such that threads at that end can preferably be used with a tapered splined wedge and nut, to compress the Rotor on to the subject Vertical Shaft, with a robust non-slip mechanical connection, that is easy to assemble and disassemble, analogous to that used on an automobile tire rim, to compress the wheel snugly on the subject wheel axel. This design allows Rotor Assemblies to be removed and easily replaced in the field.

### Fluid Distributor Assembly

The Fluid Distributor has two main functions, its exterior provides a low drag force when partially submerged in a fluid, and its interior function uses centrifugal force and up-hill Artificial Gravity Siphoning to cause fluid flow from the submerged portion of the Fluid Distributor, up a mostly radial curved tube or Penstock to an a un-submerged point just above the Reservoir surface where the fluid is expelled tangential to the Rotor 411 where a Nozzle is attached, the Nozzle 427 is mostly tangential to the Rotor, facing in a direction such that the reaction force acts to aid the initialized direction of the Rotor, and aligns with the outer most buckets of the Turbine Runner 431 and at the Turbines specified angle of attack.

Because there are both vertical conduits or tubes and horizontal radial curved conduits or tubes (Penstocks 425) involved, this housing may be constructed in two pieces, and the radial upper portion entity is viewed as an injection molded entity. Because of the hollow conduits inside, from an economic view point if nothing else, it will probably be a two piece assembly with seams along the midpoint contour of the mostly radial conduits. The vertical or barrel of the funnel and the vertical conduits inside (looking ahead will be 3, or 6 conduits) can be viewed as a cylindrical bar where the conduits are drilled out, but in practice will be fabricated from an injection mold process. The hollowed out cylinder can then preferably be aligned with the mating radial orifices and cemented together to form a one piece Fluid Distributor 421.

### Turbine & Turbine Bearing & Vertical Shaft Assembly

The Turbine Bearing 716 & Vertical Shaft 733 Assembly is an entity that can be manufactured in a competitive production environment and installed onto the Rotor 411 of the Fluid Dynamic Energy Generator/Motor. The bottom part of its shaft 733 is preferably specified to be the standard slip-on tapered spline to mate with a custom Arbor (fancy name for hub) of the Turbine Runner 431 The upper portion of its shaft 733 is specified to be compatible with the standard tapered spline slip-on fit used elsewhere in this invention, for connecting to the vertical to horizontal shaft translator Gear Box 732.

### Positive Feedback Transmission

The positive Feedback Transmission is preferably comprised of turbine shaft 435 & DG 537, but from an assembly and maintenance view point, Bearing Support 414 preferably becomes an integral part of the assembly, and is typically the last items to be installed on the rotor 411. The 3 entities preferably form a sub assembly.

The turbine shaft 435 of the subassembly preferably uses the standard tapered spline connection to the Vertical to Horizontal Shaft Gear Box 732. During assembly the shaft preferably is mated with Gear Box 732, and the DG 537 is preferably mated to the proper tooth of the SG 539, and the Bearing Support 414 is then preferably hard coupled to a recessed indenture providing alignment and sheer strength support to the Rotor 411 to which it is bolted.

### Reservoir

The baseline Reservoir fluid is typically ph balanced water with an anti-freeze additive. Other fluids including vegetable and corn oil, petroleum based oils, and eventually new blends of fluid tailored to this application including nano-technology coatings on interior and exterior surfaces to improve flow and reduce drag, are but a few of the possible alternatives.

Furthermore, the Reservoir is preferably just not fluid, it preferably contains stationary internal structures to: (i) reduce fluid drag on the submerged portion of the funnel-shaped Fluid Distributor of the Rotor assembly; and (ii) guide the large volume of energy depleted nozzle fluid (180 to 1200 gals per minute for the prototype units) from the 360 degree circumference of the reservoir where the energy depleted fluid is accumulated, and sent back down to the bottom-center of the reservoir.

As the Funnel shaped Fluid distributor is rotated, surface tension causes Reservoir fluid to spin and climb the sidewalls of the reservoir containment system. To minimize this, and its small but associated drag force on the rotor, the reservoir may house a stationary non rotating Funnel Shaped structure 777, into which the funnel shaped Fluid Distributor is positioned over forming a fluid bearing between the two funnel shapes that dramatically reduces the Fluid Drag, but also prevents the Reservoir fluid from spinning and climbing the Reservoir containment walls.

Also, the Reservoir containment structure may house a “J” shaped extrusion (not shown) that forms a plenum with the reservoir walls and bottom of the reservoir. At or near the bottom center of the reservoir the flow is directed upward toward the input port of the partially submerged distributor, in a controlled non turbulent manner where the fluid is endlessly recirculated.

### Frame and Containment Housing

The preferred embodiment of the prototype does not include a housing, but rather it consists of a platform 460 or stage that houses the entire Artificial Gravity Fueled Energy Generator/Motor. The stage may have alignment/centering cams protruding from the bottom of the stage, but accessible from the top, to allow blind positioning of the stage on the reservoir containment rim, and then to provide sufficient horizontal alignment accuracy to fit the funnel shaped Fluid Distributor symmetrically into the stationary drag reducing funnel structure 777.

It may be necessary to pressurize the inside cavity of the housing where the Rotor resides to prevent cavitation of the fluid due to external exposure to high temperatures and/or the purposeful creation of low pressure Suction Heads within the penstocks of the Fluid Distributor. In the preferred prototype embodiment, if pressurization of the reservoir fluid is to be evaluated, the entire system will preferably be placed in a pressurized chamber, the unit will be characterized and before production a frame/housing will be added.

The Frame and containment structure should also preferably include a safety protection Collar that can capture and restrain parts and sub-assemblies that might fly off the Rotor 101 due to catastrophic failures.

FIG. 8 depicts the Top view of 3-6 Channel Horizontal Turbine Rotor Assembly including Positive Feedback Transmission. This figure is very similar to FIG. 6, the key differences in the Fluid Dynamic, and Positive Feedback functional areas are:
From the fluid dynamic stand point, the key difference is the Turbine Runners have been flipped to a horizontal orientation. The Fluid Distributor 421 that houses Penstocks 425 is identical to Vertical Turbine. The nozzles that were directed tangential and in the same plane as the rotor in the Vertical Turbine case in FIG. 4 are now still directed mostly tangential, but are now pointed slightly upward by an amount equal to the angle of attack, such that vj 521 strikes the Turbine Runner 431 buckets at their optimum angle for maximum fluid power transfer.
From a Positive Feedback Transmission view point, the key difference as seen from this top view of FIG. 8 is the turbine shaft 435 is now supported by one bearing Shaft support 414 and Gear Box 732, that replaced the functionality of bearing shaft support 412 of FIG. 6.
Gear Box 732 transforms turbine runner vertical shaft 733 rotation to turbine shaft 435 rotation with a 1 to 1 gear ratio, where the direction of rotation is identical to that of turbine shaft 435 in FIG. 5.

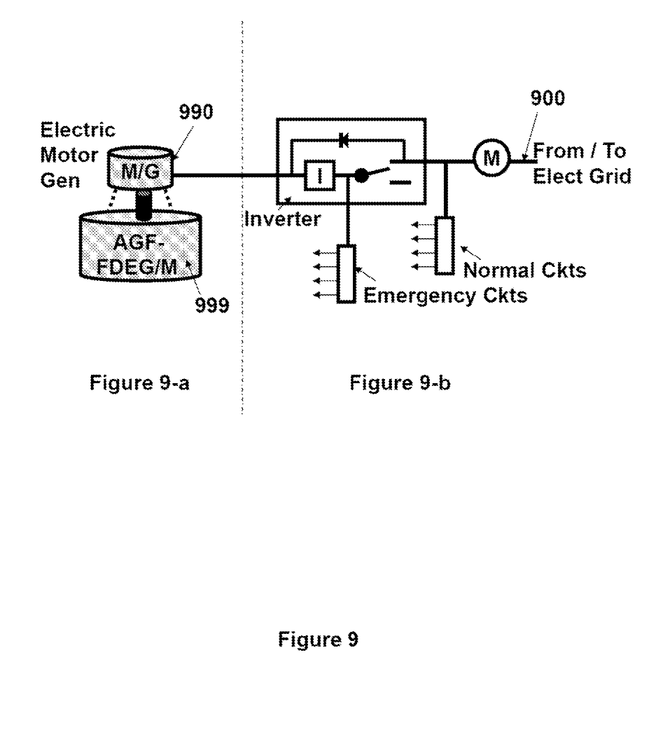

FIG. 9 depicts the end result of the transformation process, and a typical electric grid connected application.

FIG. 9-a shows the end result after transitioning the processes described in FIGS. 1 through 8 into a semi-portable Artificial Gravity Fuelled Fluid Dynamic Energy Generator/Motor 999 driving an Electric Generator 990. During start up, or after a maintenance action the electric generator 990 is configured as a grid connected motor which drives (cranks) vertical shaft 471 up to its operating rpm. For a properly scaled and loaded system, just before reaching its intended rpm, the fluid dynamic energy-power produced by the Artificial Gravity Fuelled Energy Generator/Motor 999 will exceed that of the grid connected electric motor and take control of spinning vertical shaft 471, turning the electric motor back into an electric generator 990.

FIG. 9-b depicts integrating this technology into the biggest and easiest market to capture in the world, the individual home owners market. A typical Artificial Gravity Fueled Energy Generator/Motor 999 for a home-business is the size of a home's furnace and will connect to the electrical power grid for start-up and peak power demands, and will supply power back to the Electrical Grid 900 when the home's power consumption falls below some preset value. During Electric Grid power failure, the Artificial Gravity Fuelled Fluid Dynamic Energy Generator/Motor 999 at the very minimum supplies emergency/back-up power to the home for the duration of the power failure, without batteries or energy storage devices. For a properly scaled unit the monthly energy bill (using today′ sell-back rates) will be zero.

Unless defined otherwise, all technical terms used herein have the same meaning as commonly understood by one of ordinary skill in the art to which this invention belongs. Any methods and materials similar or equivalent to those described herein also can be used in the practice or testing of the present disclosure

It must be noted that as used herein and in the appended claims, the singular forms “a”, “and”, and “the” include plural references unless the context clearly dictates otherwise.

While the present disclosure has been described with reference to the specific embodiments and examples thereof, it should be understood by those skilled in the art that various changes may be made and equivalents may be substituted without departing from the true spirit and scope of the invention. In addition, many modifications may be made to adopt a particular situation, material, composition of matter, process, process step or steps, to the objective spirit and scope of the present disclosure. All such modifications are intended to be within the scope of the claims appended hereto.

1. An Artificial Gravity Fueled Fluid Dynamic Energy Generator/Motor comprising:
a system control and brake assembly;
a main bearing vertical shaft assembly connected to said system control and brake assembly;
a platform connected to said main bearing vertical shaft assembly;
a ratchet assembly connected to said main bearing vertical shaft assembly;
a rotor connected to said main bearing vertical shaft assembly and wherein said rotor supports a fluid distributor;
a turbine shaft connected to said rotor by at least one bearing shaft support;
a turbine runner connected to said turbine shaft by a gear box;
a drive gear connected to said turbine shaft;
a sun gear dynamically interfaced with said drive gear; and
a sun gear hub extension connected to said sun gear;
wherein said fluid distributor includes at least one penstock including an associated nozzle configured to propel a fluid from a reservoir to said turbine runner.

2. The Artificial Gravity Fueled Fluid Dynamic Energy Generator/Motor of claim 1, further including a mounting flange attached to said main bearing vertical shaft assembly that provides sufficient stiffness to minimize vibrations in said rotor throughout its range of operation.

3. The Artificial Gravity Fueled Fluid Dynamic Energy Generator/Motor of claim 1, wherein the main bearing vertical shaft assembly includes:
a collar, and a thrust bearing to vertically support the rotor, and
at least one axial bearing, to provide axial stiffness to keep vibrations, harmonics, and resonances within acceptable limits.

4. The Artificial Gravity Fueled Fluid Dynamic Energy Generator/Motor of claim 1, wherein the main bearing vertical shaft assembly includes a main bearing extension that protrudes under its mounting flange a sufficient amount to protrude through the platform and provides an expanded functionality to act as a precision support structure for a upper half of the ratchet assembly which is aligned with a vertical shaft of said main bearing vertical shaft assembly.

5. The Artificial Gravity Fueled Fluid Dynamic Energy Generator/Motor of claim 1, wherein a upper half of the ratchet assembly includes an integral donut shaped hub, having a precision relationship to the functional center of said ratchet assembly, which provides a secure robust power handling connection, to platform.

6. The Artificial Gravity Fueled Fluid Dynamic Energy Generator/Motor of claim 1, wherein a bottom half of the ratchet assembly includes a hub-like indentured, slightly tapered spline, internal to the bottom half of the ratchet, that blindly engages with the sun gear hub extension that acts as a shaft, having a mating machined tapered spline where it penetrates ratchet assembly, such that when the rotor hub is pushed on to the main bearing vertical shaft, the sun gear hub extension also blindly engages with the bottom half of the ratchet assembly.

7. The Artificial Gravity Fueled Fluid Dynamic Energy Generator/Motor of claim 1, further including a hub that attaches said rotor to said main bearing vertical shaft assembly.

8. The Artificial Gravity Fueled Fluid Dynamic Energy Generator/Motor of claim 7, wherein said hub provides a permanent place to secure said sun gear such that the gear train consisting of said sun gear and said drive gear stays fully assembled even when the rotor is disconnected from a vertical shaft.

9. The Artificial Gravity Fueled Fluid Dynamic Energy Generator/Motor of claim 8, wherein said hub provides an alternate bottom mount means of supporting said rotor wherein the hub includes an inverse spline taper in the bottom of the hub to permit the rotor to sit on an alternate vertical shaft coming up from within the reservoir to a height just above the fluid surface; where said vertical shaft is protected and housed in a structural hollow column-like casing performing the function a new main bearing vertical shaft assembly.

10. The Artificial Gravity Fueled Fluid Dynamic Energy Generator/Motor of claim 1, wherein said fluid distributor is comprised of two separate entities, a first to handle at least two vertical conduit and a second to handle at least two horizontal conduits.

11. The Artificial Gravity Fueled Fluid Dynamic Energy Generator/Motor of claim 1, wherein said fluid distributor includes at least one penstock wherein a vertical feed of said penstock is positioned approximately 1.5 diameters away from center of rotation, at a small radius r1 and at a depth of at least 1.5 penstock diameters deep with the circumferential end of said at least one penstock protruding above a surface of said reservoir by a minimum of 1.5 penstock diameters.

12. The Artificial Gravity Fueled Fluid Dynamic Energy Generator/Motor of claim 1, wherein said at least one penstock is curved.

13. The Artificial Gravity Fueled Fluid Dynamic Energy Generator/Motor of claim 12, wherein said curve of said penstock begins at its point of entry at radius r1 into the horizontal rotating domain, outward to a point on the circumference of the rotor that is moving toward the normal radial.

14. The Artificial Gravity Fueled Fluid Dynamic Energy Generator/Motor of claim 1, wherein said turbine is a horizontal turbine.

15. The Artificial Gravity Fueled Fluid Dynamic Energy Generator/Motor of claim 1, wherein said turbine is a vertical turbine.

16. The Artificial Gravity Fueled Fluid Dynamic Energy Generator/Motor of claim 1, wherein said sun gear is free to spin in the clockwise direction, until the ratchet assembly detects the sun gear trying to reverse its direction of rotation and the ratchet assembly locks to a platform inhibiting the sun gear from turning.

17. The Artificial Gravity Fueled Fluid Dynamic Energy Generator/Motor of claim 1, wherein said fluid in said reservoir is one of ph balanced water, glycol base radiator fluid, vegetable oil, corn oil, petroleum based oils, and fluids including nanotechnology.

18. The Artificial Gravity Fueled Fluid Dynamic Energy Generator/Motor of claim 1, wherein said reservoir includes stationary internal structures to reduce fluid frictional drag on the fluid distributor and to guide the energy depleted fluid from the turbines back down to the bottom center of the reservoir with minimal turbulence.

19. The Artificial Gravity Fueled Fluid Dynamic Energy Generator/Motor of claim 1, wherein said platform includes alignment/centering cams protruding from the bottom of the platform, but accessible from the top, to allow blind positioning the platform on a rim of said reservoir to provide sufficient horizontal alignment accuracy to fluid distributor symmetrically into the stationary drag reducing funnel structure housed in the reservoir.

20. A method of generating artificial gravity fueled fluid power, said method comprising the steps of:
rotating a vertical shaft of main bearing vertical shaft assembly, an attached rotor, a fluid distributor attached to said rotor, and at least one penstock and its associated nozzle using an external cranking power in a first direction;
forcing a fluid through said at least one penstock into a high artificial gravity domain where its kinetic energy is increased before it exits its associated nozzle such that said fluid impacts a turbine;
rotating said turbine such that said rotation causes a rotation in a turbine shaft;
rotating at least one drive gear from the rotation of said turbine shaft;
causing the sun gear to spin in a first direction;
slowing said sun gear down;
attempting to spin said sun gear in a direction opposite to said first direction;
detecting the fluid dynamic power is greater than the external cranking power;
preventing the sun gear from rotating;
causing the drive gear to rotate in said first direction around the now stationary sun gear; and
causing drive gear to drag the rotor via its turbine shaft connection to bearing shaft support connection to the rotor.
